(19) United States
(12) Patent Application Publication
(10) Pub. No.: US 2018/0216561 A1
(43) Pub. Date: Aug. 2, 2018

(54) INTERNAL COMBUSTION ENGINE WITH A SECONDARY AIR PUMP AND METHOD FOR OPERATING AN INTERNAL COMBUSTION ENGINE WITH A SECONDARY AIR PUMP

(71) Applicant: Volkswagen Aktiengesellschaft, Wolfsburg (DE)

(72) Inventors: Florian ZINK, Bad Rappenau (DE); Jens WODAUSCH, Braunschweig (DE); Marcel LEISE, Danndorf (DE); Claus-Jürgen BECKER, Wolfsburg (DE)

(73) Assignee: Volkswagen Aktiengesellschaft, Wolfsburg (DE)

(21) Appl. No.: 15/886,015

(22) Filed: Feb. 1, 2018

(30) Foreign Application Priority Data
Feb. 2, 2017 (DE) 10 2017 201 716.3

(51) Int. Cl. F02D 41/22; F02M 35/10; F01N 3/22; B60T 17/02; B60T 13/52

(52) U.S. Cl. CPC F02D 41/22; F02M 35/10229; B60T 13/52; B60T 17/02; F01N 3/22

(57) ABSTRACT

An internal combustion engine has a secondary air pump and a method for operating an internal combustion engine with a secondary air pump. The internal combustion engine is equipped with a secondary air pump, with an exhaust gas line and with a secondary air line. In this context, a connection between the discharge side of the secondary air pump and the exhaust gas line with the secondary air line is established. Moreover, the vacuum side of a brake booster is fluidically connected to the secondary air pump.

### CROSS REFERENCE TO RELATED APPLICATIONS

This application claims priority to German Patent Application No. 10 2017 201 716.3, filed Feb. 2, 2017, which is incorporated herein in its entirety.

### BACKGROUND OF THE INVENTION

The invention relates to an internal combustion engine with a secondary air pump. Moreover, the invention relates to a method for operating an internal combustion engine with a secondary air pump.

Internal combustion engines and their operation emit undesired combustion by-products, particles and material vapors into the environment. These emissions are restricted to limit values by law. In order to comply with the limit values, among other things, devices for exhaust gas treatment are used, whereby these exhaust gas treatments often have to be assisted by secondary air pumps.

German patent specification DE 10 2004 001 831 B4 discloses an exhaust gas treatment system having a secondary air blowing device to heat up a catalytic converter. This device utilizes the momentary operating state of the engine and the momentary exhaust gas parameters in order to control the secondary air blowing device.

German patent application DE 10 2009 019 367 A1 discloses a leakage diagnostic system for a brake booster system. For this purpose, the brake booster vacuum is monitored in terms of its rate of decrease. Here, a sufficient vacuum of the brake booster can be maintained with the engine vacuum using the electric motor of a hybrid vehicle.

### SUMMARY OF THE INVENTION

The objective of the present invention is to use a secondary air pump for several functions in an internal combustion engine.

This objective is achieved according to the invention by an internal combustion engine with a secondary air pump and having the features as claimed, as well as by the method for operating an internal combustion engine with a secondary air pump as claimed. Advantageous refinements of the invention are characterized in the dependent claims.

This objective is achieved by an internal combustion engine with a secondary air pump, with an exhaust gas line and with a secondary air line. In this context, a connection between the discharge side of the secondary air pump and the exhaust gas line with the secondary air line is established. Moreover, the vacuum side of a brake booster is fluidically connected to the secondary air pump.

This arrangement entails the advantage that the vacuum side of the brake booster with the secondary air pump can undergo a pressure change. In this manner, it is possible to employ the secondary air pump not just for assisting in the exhaust gas treatment. A secondary air pump comprises a pump that can convey air into the exhaust gas line and therefore, it constitutes a secondary source of air. A secondary air pump draws a certain volume from the suction side and conveys this volume to the discharge side. Consequently, a higher pressure is present on the discharge side than on the suction side. The vacuum side of the brake booster encompasses the side of brake booster that is physically divided into two sides and that is charged with a vacuum in order to boost the braking effect. A fluidic connection constitutes a connection from one place to another place, through which a liquid or a gas can flow from one place to another place. In this context, specific pressure characteristics are not taken into consideration in these places. Therefore, the fluidic connection already constitutes a possible route from A to B through a given passage.

In one embodiment of the invention, the vacuum side of the brake booster can be fluidically connected to the suction side of the secondary air pump.

This embodiment has the advantage that the suction capacity of the secondary air pump matches the suction capacity at the vacuum side of the brake booster.

In an additional embodiment of the invention, the vacuum side of the brake booster can be fluidically connected to the discharge side of the secondary air pump.

This embodiment has the advantage that a vacuum can be indirectly generated at the vacuum side of the brake booster, for example, by means of a Venturi tube. Therefore, the capacity at the vacuum side does not have to match the capacity of the secondary air pump.

In a preferred embodiment of the invention, the fluidic connection from the vacuum side of the brake booster to the suction side of the secondary air pump can be switched by means of an actuatable valve.

A valve comprises a device that can regulate or adjust a flow of fluid in a line or in a connection point. This regulation can be executed continuously or in stages. The expression “can be switched” means that something can be intentionally changed. For instance, an actuator can move a valve into various states by means of electric signals, thereby switching it. The term “actuatable” means that a device can be impinged with electric signals. In this case, the device is configured to receive and to interpret electric signals. This embodiment entails the advantage that the connection to the vacuum side of the brake booster can be regulated. A control unit can be used in order to couple and/or coordinate the control of the internal combustion engine with the control of the valve. Thus, a predictive control can also be set which anticipates probable future occurrences on the basis of what is happening or has happened.

In one embodiment of the invention, a Venturi tube can be installed on the connection leading from the vacuum side of the brake booster to the discharge side of the secondary air pump.

This embodiment has the advantage that the vacuum side of the brake booster can be charged with a vacuum while employing very few components and being very cost effective. A Venturi tube can be any kind of T-piece of a pipeline in which a vacuum is created at a first place by a flow of fluid into the other sides.

The method according to the invention for operating an internal combustion engine, with a secondary air pump and with a secondary air line encompasses the following actions. The method entails that the secondary air pump conveys a given volume from a suction side of the secondary air pump to a discharge side of the secondary air pump. The pumping of this volume by the secondary air pump is utilized in order to change the pressure in the brake booster.

The method according to the invention has the advantage that, in addition to the main pumping function of the secondary air pump, the pumping can also be used to influence the brake booster. However, the pumping can also be employed to influence only the brake booster. In this context, a volume encompasses a spatial unit that is filled with a fluid and that is not physically separated, but rather that can be divided into a three-dimensional space as desired.

In one embodiment of the method according to the invention, a volume can be withdrawn from the brake booster and fed to the suction side of the secondary air pump.

The advantage of this embodiment is the generation of a vacuum in the brake booster, thus allowing a direct evacuation of the brake booster. Thanks to the pressure reduction, it is advantageously possible to reduce the pressure in the brake booster, thus allowing, for example, a diagnosis of the course of the pressure over time. By monitoring the pressure in this manner, it is thus possible to identify a leak in the brake booster or a malfunction. This diagnosis can only be made by plotting the pressure over time. In the case of an atypical curve, a control unit can display an error message on the dashboard of a vehicle, so as to warn the driver of a danger associated with a change in the brake behavior or else so as to prevent the car from being driven.

In one embodiment of the method according to the invention, it is provided that a volume can be withdrawn from the brake booster and fed to the discharge side of the secondary air pump through a Venturi tube.

Owing to this embodiment, it is advantageously possible to generate a vacuum in the brake booster. The build-up of this vacuum is dependent on the capacity of the volume that the secondary air pump can pump into the secondary air line and, more precisely, into the section with the Venturi tube. The dimensioning of the Venturi tube essentially determines its suction effect when a mass flow is passing through the main line. Consequently, for this method, the regulation can be advantageously replaced by the configuration of the component.

In a preferred embodiment of the method according to the invention, a gas volume can be conveyed from the discharge side of the secondary air pump into the brake booster. The pressure in the brake booster can be increased in this manner

This advantageously opens up another possibility for monitoring the pressure of the brake booster.

In another embodiment of the method according to the invention, the pressure in the brake booster can be plotted over time and can thus be monitored.

This embodiment entails the advantage that the plotting and the monitoring each provide the possibility to make a diagnosis and to carry out monitoring. The terms “monitoring possibility” and “monitoring” can mean, for instance, that a control unit or a computer compares the measured values, the curves and the changes to references and/or limit values and, if the deviation is too great, it generates an error log, a diagnosis log or an alert log.

### BRIEF DESCRIPTION OF THE DRAWINGS

Additional advantages and advantageous embodiments and refinements of the invention will be presented on the basis of the description below making reference to the figures. The following is specifically shown:

FIG. 1 shows a preferred embodiment of the internal combustion engine according to the invention, with a secondary air pump;

FIG. 2 shows another preferred embodiment of the internal combustion engine according to the invention, with a secondary air pump;

FIG. 3 shows another preferred embodiment of the internal combustion engine according to the invention, with a secondary air pump; and

FIG. 4 shows a preferred flowchart of the method according to the invention, for operating an internal combustion engine, with a secondary air pump.

### DETAILED DESCRIPTION OF THE INVENTION

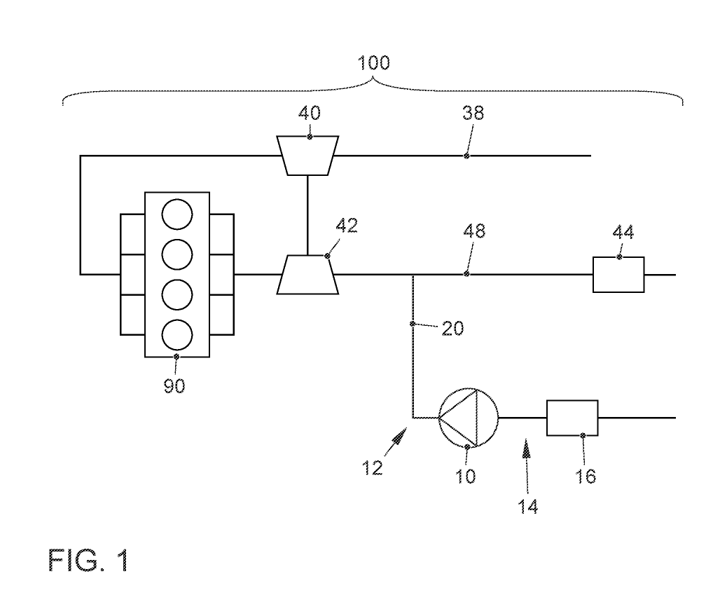

FIG. 1 shows a preferred embodiment of the internal combustion engine 100 according to the invention, with a secondary air pump 10. Air coming from a fresh gas line 38 flows through the compressor 40 of the turbocharger via the intake manifold and into the engine block 90. From the engine block 90, the exhaust gas passes through the turbine 42 of the turbocharger and into exhaust gas line 48. At least one catalytic converter 44 and/or at least one particulate filter can be arranged in the exhaust gas line 48.

Downstream from the turbine 42, a secondary air line 20 opens up into the exhaust gas line 48. The secondary air line 20 can especially open up into the exhaust gas line 48 between the at least one catalytic converter 44 and the turbine 42. According to the invention, the secondary air line 20 can open up into the exhaust gas line 48 at any desired place. Preferred places can be in the exhaust manifold downstream from the engine block 90, directly in front of or behind the turbine 42 and/or upstream from a component that serves to treat the exhaust gas (this can be, for example, a catalytic converter 44 and/or a particulate filter).

The secondary air line 20 is divided into two sides by a secondary air pump 10. A discharge side 12 and a suction side 14 constitute the two sides of the secondary air line 20. In this context, the discharge side 12 of the secondary air line 20 is the side through which the secondary air pump 10 conveys air. Therefore, the discharge side 12 is the side located downstream from the secondary air pump 10. The suction side 14 is the side that is utilized by the secondary air pump 10 to draw in air. Therefore, the suction side 14 is the side upstream from the secondary air pump 10.

The embodiment according to the invention shown in FIG. 1 has the brake booster 16 arranged on the suction side 14. As a result, the power booster 16 can be charged with a vacuum from the suction side 14 by means of the secondary air pump 10. Especially preferably, in a device according to the invention, this is done on the vacuum side of the brake booster 16.

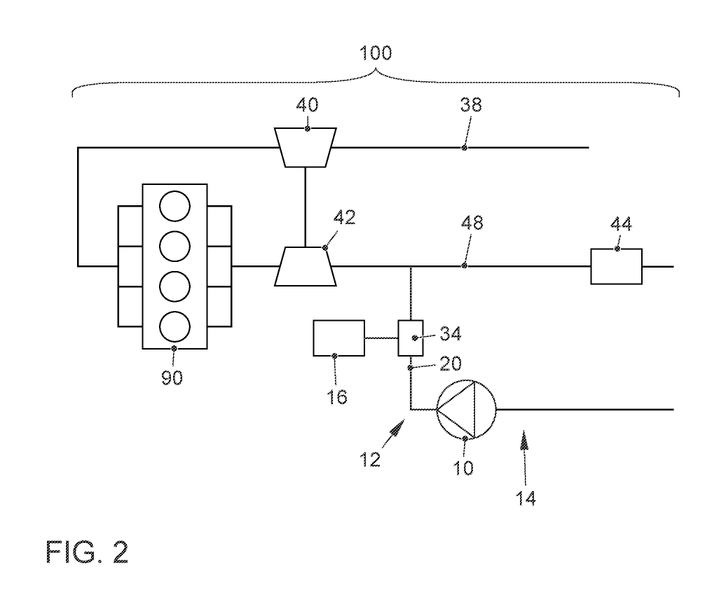

FIG. 2 shows a preferred embodiment of the internal combustion engine 100 according to the invention, with a secondary air pump 10. Air coming from a fresh gas line 38 flows through the compressor 40 of the turbocharger via the intake manifold and into the engine block 90. From the engine block 90, the exhaust gas passes through the turbine 42 of the turbocharger and into exhaust gas line 48. At least one catalytic converter 44 and/or at least one particulate filter is/are arranged in the exhaust gas line 48.

Downstream from the turbine 42, a secondary air line 20 opens up into the exhaust gas line 48. The secondary air line 20 can especially open up into the exhaust gas line 48 between the at least one catalytic converter 44 and the turbine 42. According to the invention, the secondary air line 20 can open up into the exhaust gas line 48 at any desired place. Preferred places can be in the exhaust manifold downstream from the engine block 90, directly in front of or behind the turbine 42 and/or upstream from a component that serves to treat the exhaust gas (this can be, for example, a catalytic converter 44 and/or a particulate filter).

The secondary air line 20 is divided into two sides by a secondary air pump 10. A discharge side 12 and a suction side 14 constitute the two sides of the secondary air line 20. In this context, the discharge side of the secondary air line 20 is the side through which the secondary air pump 10 conveys air. Therefore, the discharge side 12 is the side located downstream from the secondary air pump 10. The suction side 14 is the side that is utilized by the secondary air pump 10 to draw in air. Therefore, the suction side 14 is the side upstream from the secondary air pump 10.

A T-piece in the form of a Venturi tube 34 is formed on the discharge side 12 of the secondary air line 20. This Venturi tube 34 establishes the connection between a brake booster 16 and the secondary air line 20 on the discharge side 12.

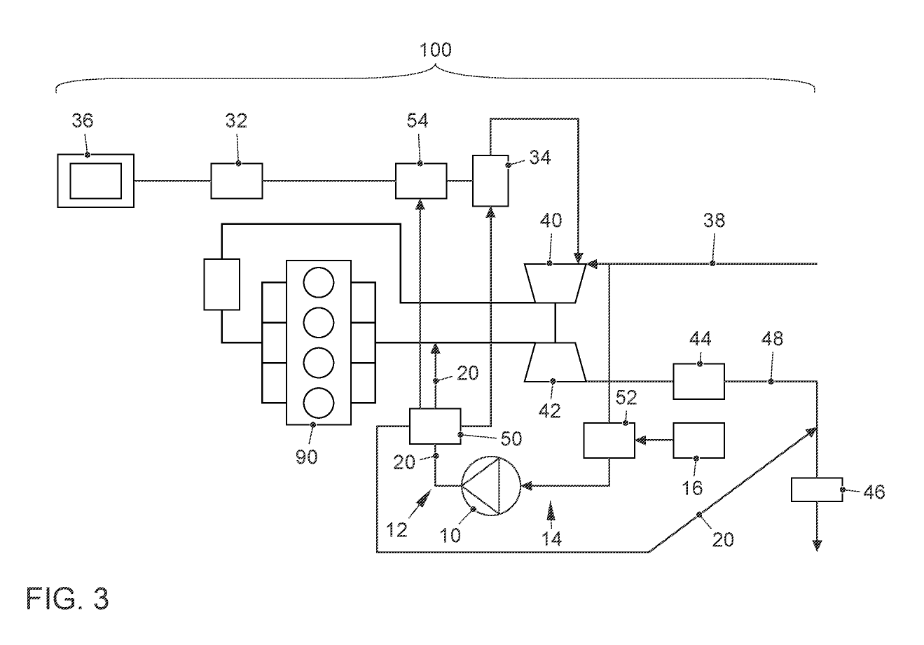

FIG. 3 shows a preferred embodiment of the internal combustion engine 100 according to the invention, with a secondary air pump 10. The internal combustion engine 100 comprises a fresh gas line 38, an engine block 90 and an exhaust gas line 48. The fresh gas line 38 can comprise an air filter and it is equipped with a compressor 40 of a turbocharger. Downstream from the compressor 40, there is a throttle valve on the fresh gas line 38 between the compressor 40 and the engine block 90. Downstream from the throttle valve, there is an intake manifold that divides the fresh gas line 38 into the individual combustion chambers of the engine block 90. As it leaves the engine block 90, the exhaust gas is combined in the exhaust gas line 48 by an exhaust manifold.

Downstream from the exhaust manifold, the exhaust gas line 48 leads through the turbine 42 of the turbocharger. A catalytic converter 44 is situated downstream from turbine 42 on the exhaust gas line 48. A catalytic converter 44 can generally be any exhaust-gas treatment component that at least partially converts a constituent of the exhaust gas into a different substance. The catalytic converter 44 can be installed so as to be either close to or far away from the engine. The components of an exhaust-gas system are installed far away from the engine, namely, in the undercarriage of a vehicle with an internal combustion engine according to the invention. The catalytic converter 44 can be situated either upstream from or downstream from a turbine 42 in the exhaust gas line.

A particulate filter 46 is installed downstream from the catalytic converter 44. Here, the term particulate filter 46 describes a component in an exhaust gas line 48 that has been installed for purposes of reducing the particle concentration in the exhaust gas flow downstream from a particulate filter 44 in comparison to the particle concentration in the exhaust gas flow upstream from a particulate filter 44. In particular, the particulate filter can be an Otto particulate filter or a diesel particulate filter. Otto particulate filters differ from diesel particulate filters, for example, in terms of the structural characteristics of the substrate used for the filtering as well as in terms of the coatings of the substrate used for the filtering. This difference can be ascribed, among other things, to the fact that the particles in the exhaust gas of Otto engines have a different structure and, as a rule, have a smaller diameter than the particles in the exhaust gas of diesel engines.

The internal combustion engine 100 comprises not only the above-mentioned structures but also a line system for blowing in air. The line system is part of the internal combustion engine 100 and serves to improve its operation.

A secondary air line 20 branches off from the fresh gas line 38, leading to a secondary air pump 10. The secondary air pump 10 can convey a regulatable air mass flow or else only a certain air mass flow. This has the advantage that the air mass can be determined by the pump control unit or by regulatable valves. The secondary air line 20 also constitutes a fluidic connection between the secondary air pump 10 and the fresh gas line 38. In this context, a preferred arrangement is one in which this fluidic connection branches off downstream from an air filter of the fresh gas line 38 since, in this manner, the air filter advantageously filters the air for multiple components.

The secondary air pump 10 can introduce an air flow into the secondary air line 20 as well as into its other components. The secondary air line 20 downstream from the secondary air pump 10 is the discharge side 12. The secondary air line upstream from the secondary air pump 10 is the suction side 14. A 3/2-way valve 52 is arranged on the suction side 14 of the secondary air line. A brake booster 16 is arranged on the other path of the 3/2-way valve 52. Preferably, the brake booster 16 can be fluidically connected to the vacuum side of the brake booster 16 by means of the 3/2-way valve 52. In a preferred variant of the device according to the invention, the brake booster 16 can also be fluidically connected to the X/Y valve 54, thus having a connection to the discharge side 12 of the secondary air line 20. According to the invention, an X/Y valve 54 can be a 3/2-way valve or another valve that can selectively switch between the three connections of the valve.

The air flow of the secondary air line 10 can be distributed and regulated among the possible secondary air lines 20 by means of a 5/2-way valve 50. In this context, the 5/2-way valve 50 can either distribute the air flow continuously among the connected lines or else it can selectively activate only one line at a time. Consequently, the 5/2-way valve 50 can advantageously regulate and distribute the air flow of the secondary air pump 10. In this embodiment of the invention, the secondary air line 20 leads from the 5/2-way valve 50 to the exhaust gas line 48 at a place upstream from the particulate filter 46 and opens up into the exhaust gas line 48 at this place. Thus, by means of the secondary air line 20 in conjunction with the secondary air pump 10 and the 5/2-way valve 50, an air flow can be introduced into the exhaust gas line 48 in order to regenerate the particulate filter 46. In this manner, the particulate filter 46 can be regenerated in an advantageous way without having to adjust the engine in order to convey more oxygen into the exhaust gas line 48. In this embodiment of the invention, the 5/2-way valve 50 can also be used to charge the other components of the secondary air line 20 with an air flow of the secondary air pump 10.

These other components of the secondary air line 20 open up into the exhaust gas line 48, among other places, upstream from the catalytic converter 44. A catalytic converter 44 can be heated up very advantageously by passing an air flow through the other components of the secondary air line 20. An exothermic reaction between combustible constituents of the exhaust gases and the oxygen of the introduced air flow then provides the energy to heat up the catalytic converter 44 in a manner that is advantageous in comparison to having to adjust the engine in order to provide this heat.

The 5/2-way valve 50 is also fluidically connected to another part of the secondary air line 20. This part extends all the way to the fresh gas line 38 and it opens up into the fresh gas line 38 or into the compressor 40 directly before compressor 40. In this embodiment according to the invention, a T-piece in the form of a Venturi tube 34 is arranged in this part of the secondary air line 20. This T-piece in the form of a Venturi tube 34 has a branch. The branch establishes a connection to a canister for fuel vapors 32. In this context, the canister for fuel vapors 32 is fluidically connected to the fuel tank 36 of the internal combustion engine 100. When an air flow is passing through this part of the secondary air line, the canister for fuel vapors 32 is charged with a vacuum by the Venturi tube 34, which can especially be configured as a Venturi nozzle. In this manner, the fuel vapors are evacuated from the canister for fuel vapors 36, from the branch and from the fuel tank 36. Subsequently, the fuel vapors, together with the air flow, are conveyed into the fresh gas line 38. The discharging of the fuel vapors out of the canister for fuel vapors 32 is particularly advantageous when the fuel vapors are reversibly adsorbed in an activated carbon filter. The activated carbon filter can especially be arranged in the canister for fuel vapors 32.

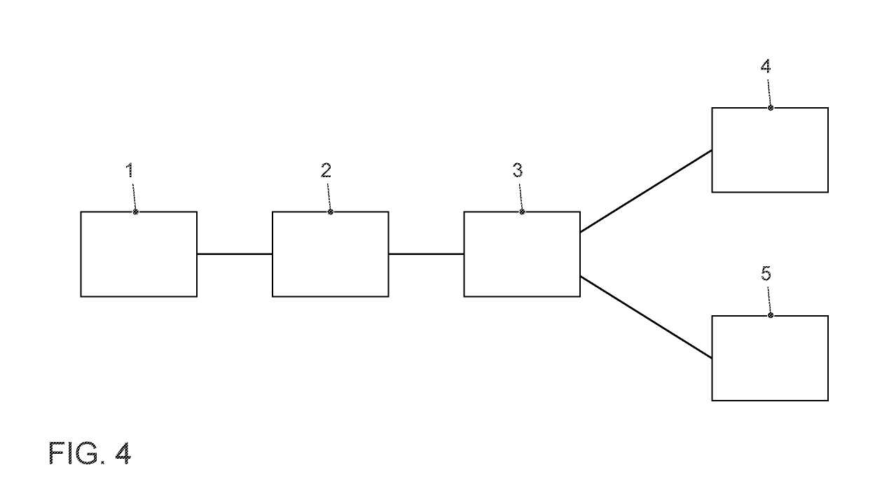

FIG. 4 shows a preferred flowchart of an embodiment of a method according to the invention. In a first step 1, the internal combustion engine 100 of a vehicle is started. In step 2, the vehicle begins its driving operation. In step 3, the pressure in a brake booster is checked. The pressure can preferably be ascertained stationarily with a single measurement or else with several measurements over a certain period of time. In this context, it is crucial for certain limit values to be observed (these values can be stored, for example, in the control unit of the internal combustion engine).

If the pressure or vacuum in the brake booster should have to be changed, then in step 8 the following can take place. The secondary air pump is activated in order to change the vacuum in the brake booster. In this process, the pressure in the brake booster always changes in both chambers. Depending on the design of the device, several valves have to be switched in order to reduce the pressure in the brake booster. Step 8 continues to be carried out until the appropriate pressure has been set.

If it is ascertained in step 4 that the pressure in the brake booster is correct, according to the invention, at least the following functions of the secondary air pump 10 can be carried out. For one thing, secondary air can be blown into the exhaust gas line. For instance, the secondary air can be used to regenerate an Otto particulate filter. For instance, the secondary air can be also used to regenerate a catalytic converter. For instance, the secondary air can be used to heat up an exhaust-gas system. All of this takes place as a result of the increased content of oxygen in the exhaust gas due to the secondary air.

The air flow of the secondary air pump can also be employed to effectuate the sealing of the system of the fuel tank. For this purpose, the system can comprise a fuel tank, various lines, fuel pumps and/or adsorption means. In this context, the adsorption means can be activated carbon filters or any other means that can reversibly bind fuel and/or fuel vapors.

### LIST OF REFERENCE NUMERALS

1 first step
2 second step
3 third step
4 fourth step
5 fifth step
10 secondary air pump
12 discharge side
14 suction side
16 brake booster
20 secondary air line
32 canister for fuel vapors
34 Venturi tube
36 fuel tank
38 fresh gas line
40 compressor
42 turbine
44 catalytic converter
46 particulate filter
48 exhaust gas line
50 5/2-way valve
52 3/2-way valve
54 Y/N valve
90 engine block
100 internal combustion engine

1. An internal combustion engine (100) comprising:
a secondary air pump (10),
an exhaust gas line (48) and
a secondary air line (20) which establishes a connection between a discharge side (12) of the secondary air pump (10) and the exhaust gas line (48),
wherein a vacuum side of a brake booster (16) is fluidically connected to the secondary air pump (10).

2. The internal combustion engine (100) with a secondary air pump (10) according to claim 1, wherein the vacuum side of the brake booster (16) is fluidically connected to the suction side (14) of the secondary air pump (10).

3. The internal combustion engine (100) with a secondary air pump (10) according to claim 1, wherein the vacuum side of the brake booster (16) is fluidically connected to the discharge side (12) of the secondary air pump (10).

4. The internal combustion engine (100) with a secondary air pump (10) according to claim 3, wherein the fluidic connection from the vacuum side of the brake booster (16) to the discharge side (12) of the secondary air pump (10) can be switched by means of an actuatable valve.

5. The internal combustion engine (100) with a secondary air pump (10) according to claim 3, wherein a Venturi tube (34) is installed on the fluidic connection leading from the vacuum side of the brake booster (16) to the discharge side (12) of the secondary air pump (10).

6. A method for operating an internal combustion engine (100) with a secondary air pump (10), an exhaust gas line (48) and a secondary air line (20), comprising:
conveying, by the secondary air pump (10), of a given volume from a suction side (14) of the secondary air pump (10) to a discharge side (12) of the secondary air pump (10),
wherein the conveying of this volume by the secondary air pump (10) is utilized to change the pressure in the brake booster (16).

7. The method for operating an internal combustion engine (100) with a secondary air pump (10) according to claim 6, further comprising withdrawing a volume of gas from the brake booster (16) and feeding it to the suction side (14) of the secondary air pump (10).

8. The method for operating an internal combustion engine (100) with a secondary air pump (10) according to claim 6, further comprising withdrawing a volume of gas from the brake booster (16) and feeding it to the discharge side (12) of the secondary air pump (10) through a Venturi tube (34).

9. The method for operating an internal combustion engine (100) with a secondary air pump (10) according to claim 6, further comprising conveying a gas volume from the discharge side (12) of the secondary air pump (10) into the brake booster (16), thus increasing the pressure in the brake booster (19).

10. The method for operating an internal combustion engine (100) with a secondary air pump (10) according to claim 8, further comprising plotting the pressure in the brake booster (16) over time and monitored the pressure in the brake booster (16).
